(19) United States
(12) Patent Application Publication
(10) Pub. No.: US 2014/0163895 A1
(43) Pub. Date: Jun. 12, 2014

(54) SYSTEM AND METHOD FOR ASSESSING HEALTH RISK FOR MIXED BREED ANIMALS

(71) Applicant: Noam Pik, Victoria (AU)

(72) Inventor: Noam Pik, Victoria (AU)

(21) Appl. No.: 14/104,484

(22) Filed: Dec. 12, 2013

(30) Foreign Application Priority Data
Dec. 12, 2012 (AU) 2012905418

(51) Int. Cl. G06F 19/00

(52) U.S. Cl. CPC G06F 19/3431
USPC 702/19

(57) ABSTRACT

There is disclosed a computer-implemented method of assessing health risk for a mixed breed animal, the method including: providing disease data, the disease data including disease scores for a plurality of candidate diseases for each of a plurality of breeds; receiving biological data relating to the mixed breed animal, the biological data including identification of two or more parent breeds which are in the ancestry of the mixed breed animal; determining disease scores, from the disease data, for the two or more parent breeds; summa rising the disease scores across the two or more parent breeds to generate a combined health risk score for each of the candidate diseases; and generating, from the combined health risk scores, a ranked list of diseases.

### FIELD OF THE INVENTION

The present invention relates to methods and systems for assessing health risk for mixed breed animals, especially (but not exclusively) mixed breed companion animals such as dogs and cats. The health risk assessment can be used by vets to provide personalised treatment or disease prevention plans, by insurance companies to conduct risk management, or for owners or breeders to conduct risk assessment prior to purchasing, an animal.

### BACKGROUND

Approaches to pet care have become increasingly sophisticated, especially in view of the recent increase in availability of genetic testing, and of information on heritable diseases in animals. It has previously been known, for example, that certain breeds of dog are more susceptible to particular diseases than others. Accordingly, vets may choose to recommend a tailored programme to manage prevention, diagnosis and treatment of diseases based on the particular breed, i.e. genetic characteristics, of a dog.

An abundance of information regarding disease occurrence and severity for pure-breed animals is available. For example, websites such as that of the Orthopedic Foundation for Animals, located at http://offa.org, accumulate and provide access to statistics relating to occurrence of conditions such as hip or elbow dysplasia, cardiac disease and thyroid disease. However, in treating a particular animal, vets face a significant challenge in locating appropriate information for that animal. In addition, although information is widely available for pure-breed animals, information for mixed breed animals is, at present, far harder to come by.

There remains a need to facilitate access by vets and pet owners to information which enables risk assessment and health management for mixed breed animals on an individual basis.

### SUMMARY

In one aspect, there is provided a computer-implemented method of assessing health risk for a mixed breed animal, the method including:
providing disease data, the disease data including disease scores for a plurality of candidate diseases for each of a plurality of breeds;
receiving biological data relating to the mixed breed animal, the biological data including identification of two or more parent breeds which are in the ancestry of the mixed breed animal;
determining parent disease scores, from the disease data, for the two or more parent breeds;
summarising the parent disease scores across the two or more parent breeds to generate a combined health risk score for each of the candidate diseases; and
generating a ranked list of diseases ordered by their respective combined health risk scores.

Preferably, respective disease scores represent a combined severity and incidence for respective candidate diseases in respective breeds. The severity may be assessed according to a combination of severity parameters. The severity parameters may include one or more of: age at fatality of the disease, whether the disease can be cured, whether the disease shortens lifespan, whether the disease is painful or irritating, whether the disease affects quality of life, whether treatment is available for the disease, whether the disease is expensive for an owner of the mixed breed animal, whether it is possible to screen for the disease, or whether the disease is distressing for the owner.

The method may further include, on the basis of the biological data, applying a filter to the plurality of candidate diseases to remove diseases which are not relevant to the mixed breed animal. The biological data may include one or more of age, sex and weight of the mixed breed animal. The disease data may include mode of inheritance criteria associated with each of the candidate diseases, and the filter may be applied by comparing the biological data with the mode of inheritance criteria.

In certain embodiments, the method includes generating, on the basis of the ranked list, a recommended vet schedule for the mixed breed animal.

In another aspect, there is provided a system for assessing health risk of a mixed breed animal, including at least one processor which is configured to perform the method as disclosed above.

In yet another aspect, there is provided a system for assessing health risk of a mixed breed animal, including:
a data store including disease data, the disease data including disease scores for a plurality of candidate diseases for each of a plurality of breeds;
a management component which is configured to receive biological data relating to the mixed breed animal, the biological data including identification of two or more parent breeds which are in the ancestry of the mixed breed animal; and
a risk analysis component which is configured to:
   determine parent disease scores, from the disease data, for the two or more parent breeds;
   summarise the parent disease scores across the two or more parent breeds to generate a combined health risk score for each of the candidate diseases; and
   generate a ranked list of diseases ordered by their respective combined health risk scores.

### BRIEF DESCRIPTION OF THE DRAWINGS

Embodiments of the invention will now be described, by way of non-limiting example only, with reference to the accompanying drawings in which:

FIG. 1 is a block diagram of a system according to an embodiment of the invention;

FIG. 2 is a block diagram of a client device of the system of FIG. 1;

FIG. 3 is a block diagram showing components of the system in more detail;

FIG. 4 is a block diagram of data structures used by the system;

FIG. 5 is a flow diagram showing steps of a method implemented by the system;

FIG. 6 is a screen shot of an exemplary user interface of the system; and

FIG. 7 is an example of a spreadsheet for calculating a disease score.

### DETAILED DESCRIPTION

Embodiments of the invention combine genetic (breed) and other biological data (e.g. age, sex, weight) of individual pets to assess disease risk and to deliver personalized wellness plans which may include:
A list (for example, a top 10 list) of the most relevant heritable diseases the particular pet may be at risk of developing in the future. Associated with each disease in the list is information regarding the disease, how to screen for and prevent the disease, and at what ages the screening and/or preventative treatment should occur.
A list of other less common or less devastating diseases which are possible for the individual pet, but without the detailed description and screening and prevention information.
Relevant information about nutrition and behaviour that is specific to the individual pet.

The particular examples described herein relate to personalised wellness programs for mixed breed dogs. However, it will be appreciated that the methods and systems described below may be readily adapted to other animals, such as cats or other companion animals, sports or racing animals (horses, greyhounds etc.) or herd animals, for example.

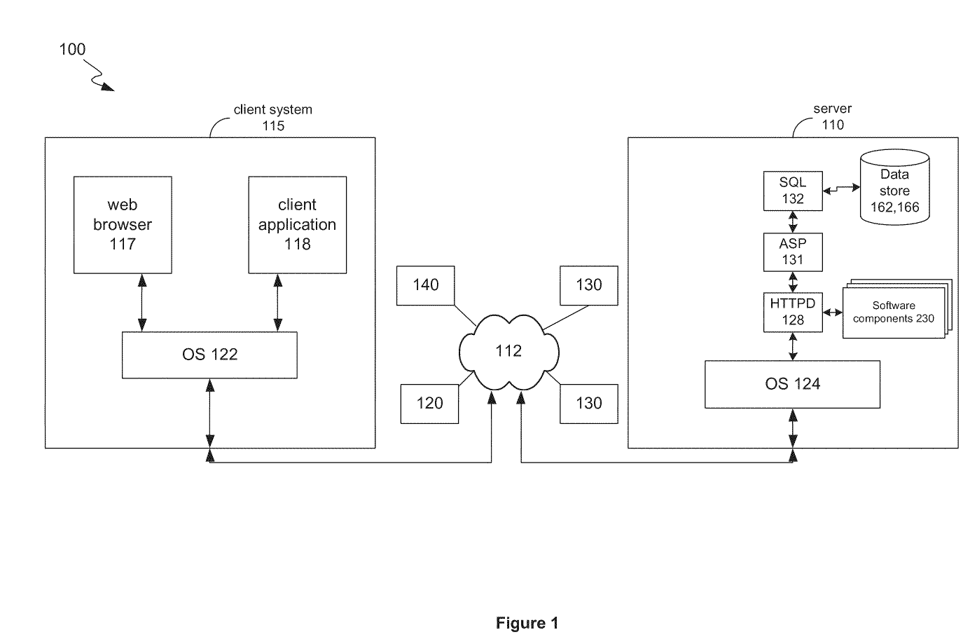

Referring generally to FIG. 1, a system 100 for assessing disease risk for a mixed breed animal is described in further detail. System 100 comprises a server system 110 and a client computing device 115 in communication with each other over a network 112, such as a private network within a single organisation or a related group of organisations. In other embodiments, the network 112 may comprise a public network such as the Internet.

System 100 further comprises a data storage system 166 accessible to server system 110 for storing data pertinent to operation of server system 110 and provision of service to one or more client computing devices 115. System 100 may communicate with at least one third party server 130 and may access web services 140 accessible to server system 110 and client computing device 115 over network 112.

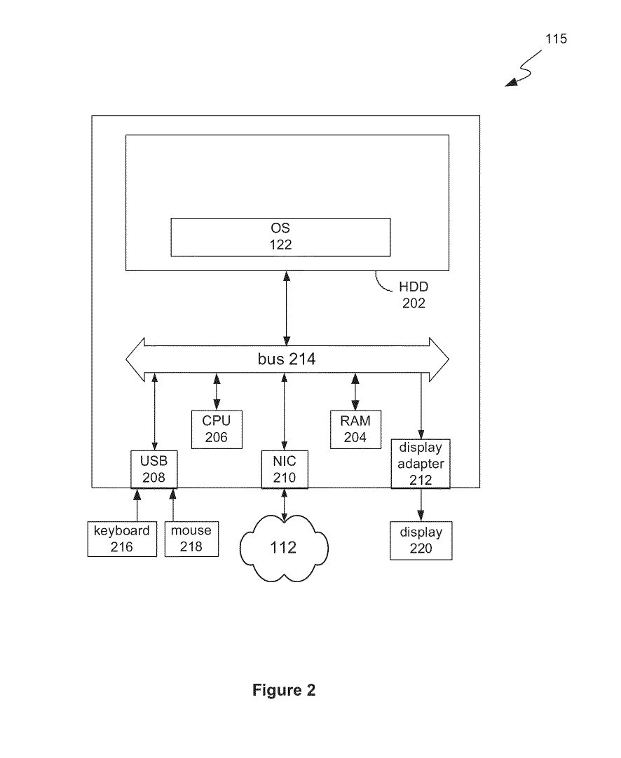

With reference to FIG. 2, client computing device 115 may comprise a desktop, mobile or handheld computing device having at least one processor (e.g. CPU 206), one or more forms of memory 202, 204, an operating system 122 and a user interface. The memory may comprise volatile (e.g. RAM 204) and non-volatile (e.g. hard disk drive 202, solid state drive, Flash memory and/or optical disc) storage. The user interface may comprise a display 220 and at least one input device, such as a touch-screen, a keyboard 216, mouse 218, stylus, speech recognition subsystem or other peripheral device that can be used for providing user input to client computing device 115. Server system 110 may have similar components and/or features.

A number of software applications or applets may be executing or executable by the at least one processor 206 to perform various device-related functions. Such applications may be stored in the non-volatile memory 202 of computing device 115. At least one such software application includes a browser application 117 for enabling a user to navigate to sites accessible over the network 112 to receive content therefrom. Alternatively, or in addition, a particular client software application 118 may execute on client system 115 using operating system 122 to cooperate with server system 110 to facilitate the methods described herein.

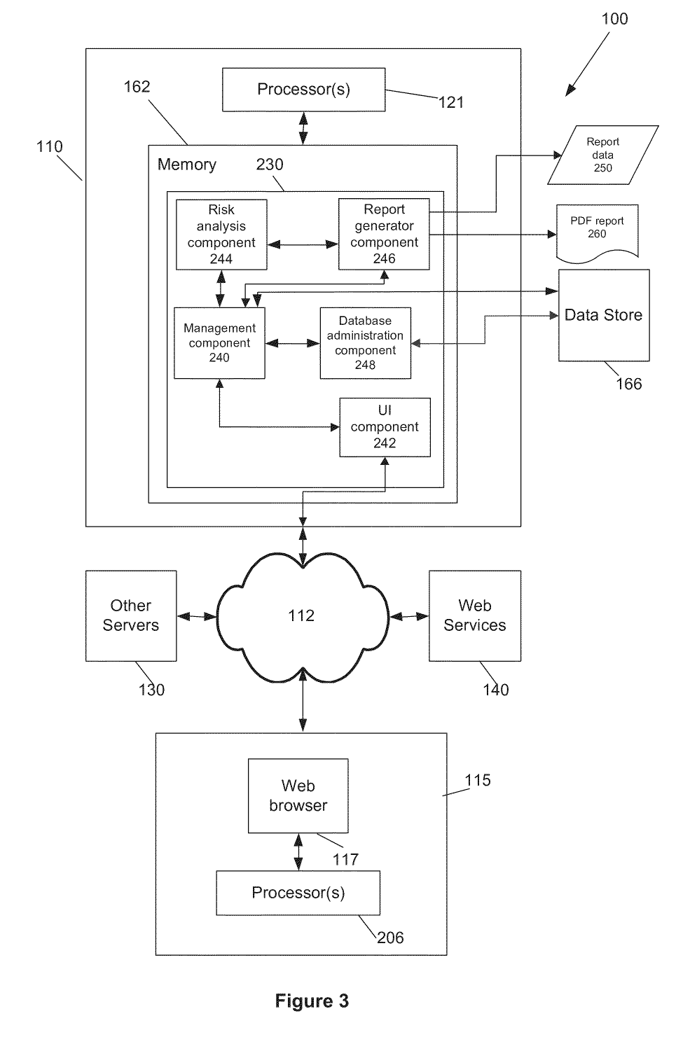

In the example of system 100 illustrated in FIG. 3, browser application 117 is used to communicate with server system 110 to provide input thereto and to request content therefrom, in the form of one or more web pages provided as program code executable by the browser application 117. According to such embodiments, server system 110 is configured to provide displays of information to a user viewing web pages via browser application 117.

Server system 110 comprises at least one processing device 121, and may comprise multiple processing devices operating in cooperation and/or parallel to operate web server functions 128 (e.g. using a hypertext transfer protocol daemon (HTTPD)), data processing functions and data storage and retrieval functions (e.g. using structured query language (SQL) support 132) in conjunction with data store 166. Server system 110 may also comprise scripting language support 131, such as Microsoft™ ASP, ASP.NET or PHP.

Server system 110 may comprise or have access to suitable non-volatile data storage 162 separate to data store 166 for storing executable program code to enable server system 110 to perform its functions, including those functions described herein. The program code comprises an operating system 124 and a number of software components 230 (described in further detail below) for managing server-side functions. Optionally, the program code executable by the server system 110 may further comprise an administration module (not shown) and a data security module (not shown) to perform normal administrative and security functions in relation to the system 100. Data store 166 may comprise a localised or distributed database storing data records 400 for heritable diseases for each breed of dog. Data store 166 may also be used by server system 110 to store data in relation to execution of the functions described below.

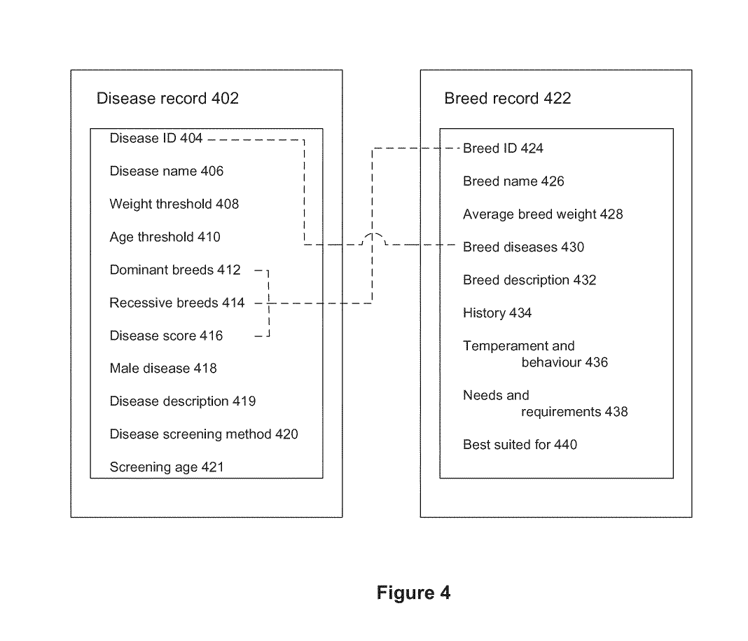

As shown in FIG. 4, database 166 includes data records 400 corresponding to diseases 402 and breeds of dog 422. Database 166 may also include data records required for maintenance of user accounts, processing of orders and payments and so on (not shown). Alternatively, those data records may be stored in a separate database, with database 166 being a dedicated disease database.

Data records 400 include a breed record 422 for each breed of dog. Each breed record 422 includes:
a breed identifier (ID) 424;
breed name 426;
average (adult) breed weight 428;
breed disease list 430: a string containing a list (e.g., comma-separated) of disease IDs 404 corresponding to diseases which the breed 424 is susceptible to;
breed description 432: a string containing a description of typical characteristics of breed 424;
history 434: a string containing information regarding the history of the breed (e.g. that the breed was traditionally used as a hunting dog and has been known to exist since a particular date);
temperament and behaviour 436: a string describing typical characteristics of the breed's temperament and behaviour (e.g. pack hound, good with children, prone to digging or chewing);
needs and requirements 438: a string describing typical requirements for the breed (e.g. requires a large yard to be able to run freely; needs frequent exercise; yard must be secured against escape); and
best suited for 440: a string describing the ideal setting for the breed (e.g. a home with plenty of room and frequent company).

Each disease has a disease record 402. Disease record 402 includes:
disease ID 404;
disease name 406;
weight threshold 408: indicates whether the disease only affects animals above or below a certain weight. The weight threshold can be composed of two values: a numerical value indicating the size of the threshold, and a character value (e.g. “<” or “>”) indicating whether the threshold is an upper limit or a lower limit;
age threshold 410: as for weight threshold 408, can be composed of two values (numerical value and character value);
dominant breeds 412: a character-valued list (for example, a comma-separated list) of breed IDs 424 for which the disease is inherited in dominant mode;
recessive breeds 414: a character-valued list of breed IDs for which the disease is inherited in recessive mode;
disease score 416: a numerical value indicating a combined severity and incidence score for the disease, calculated in a manner which will be described later;
male disease 418: a value (e.g. a character value such as “Y”) indicating whether the disease is X-linked and therefore inherited by males only;
disease description 419: string describing the nature of the disease, including diagnosis, symptoms and so on;
disease screening method 420: string describing how the disease can be detected; and
most appropriate age for screening 421: numerical value indicating the age at which the disease should be screened for.

As will be apparent to those skilled in the art, alternative data structures may be used to store the breed and disease data. For example, rather than storing character-valued lists of IDs, which may be cumbersome to manipulate and query, the lists may be stored in separate tables. In one example, database 166 may include a disease scores table which includes columns containing breed IDs, disease IDs, and disease scores, i.e. each row of the table includes the disease score corresponding to a given combination of breed ID and disease ID.

The disease scores for a given disease will typically vary across breeds, but may be identical for some of the breeds. If this is the case then it may be convenient to define a default disease score for the disease, and include an additional field which contains an indication of whether the score should vary from the default (or which contains the actual non-default score).

The software components 230 include (with reference to FIG. 3): a management component 240, a user interface (UI) component 242; a risk analysis component 244; report generator components 246; and a database maintenance component 248.

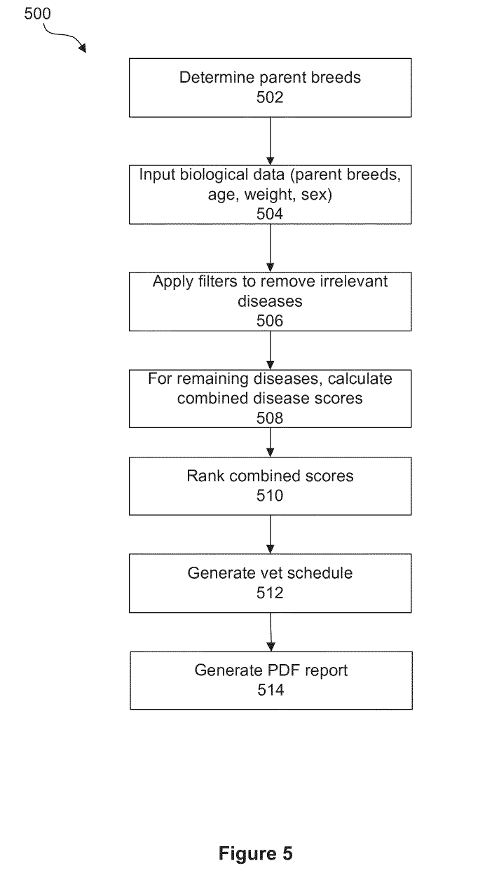

Management component 240 is responsible for the overall management of server-side functions performed as part of process 500 shown in FIG. 5. UI component 242 is responsible for serving pages to web browser 117 and for receiving input (e.g., in a web form) from the user's web browser 117. Risk analysis component 244 processes the received input to generate disease risk information. Report generator component 246 incorporates the disease risk information, and other information, into a report which can be served to the web browser 117 and/or written to a file (e.g. in a standard file format such as Portable Document format (PDF) of Adobe Systems Inc) for delivery to the user. Database maintenance component 248 permits a user with sufficient access privileges (generally, an administrator or another user with elevated write privileges for database 166) to insert into or edit records in database 166, for example to add or edit disease records 402 or breed records 422.

As used in this specification, the term “component” (alternatively, “module”) is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. Each thread has an associated “context” which is the volatile data associated with the execution of the thread. A thread's context includes the contents of system registers and the virtual address belonging to the thread's process. Thus, the actual data comprising a thread's context varies as it executes.

The interaction between user interface and system functions is described in further detail below.

A user of system 100 (for example, a veterinarian), via client device 115, accesses an ordering page (not shown) generated by management component 240 and served to web browser 117 (or to client component 118) by UI component 242. The ordering page may include controls to select optional features, such as delivery of a PDF report 260 to be generated using the output of process 500.

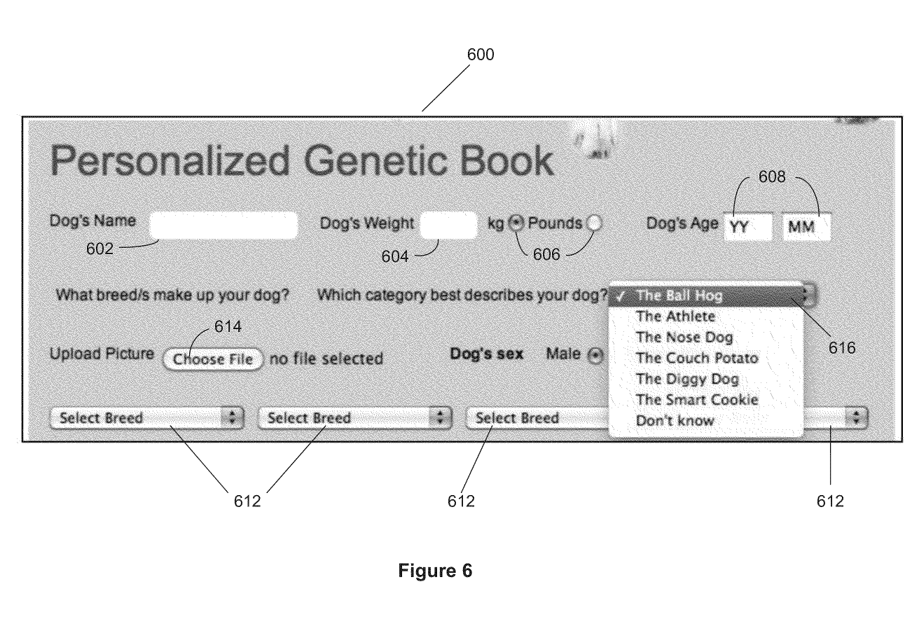

On submission of an order, a data input page 600 (FIG. 6) is served to browser 117. The data input page 600 includes data entry areas for the user to enter the dog's name (text box 602), weight (text box 604 and radio buttons 606), age (text boxes 608), and sex (radio button 610 to indicate the subject animal is male, and a second radio button, not shown, to indicate female). A series of drop-down boxes 612 are provided for the user to select, in each text box, a breed which forms part of the dog's ancestry (a parent breed). Up to four different parent breeds can be selected in the example depicted, though it will be appreciated that a higher number of selections can be accommodated, for example up to 8 different selections. Data input page 600 also includes a control 614 which, if clicked, prompts the user to upload a photo, to optionally form part of the dog's personalised genetic report 260 (as will be discussed later). Further, data input page 600 may include a drop-down box 616 which permits the user to select the dog's personality type.

The parent breeds to be entered can be determined (step 502) based on any pedigree information which may be available to the pet owner or veterinarian. Alternatively, the parent breeds can be determined by genotyping the subject animal (using microsatellite markers or SNPs, for example) and inferring or estimating the parent breed makeup using a naïve Bayes classifier or other probabilistic method. One such method for inferring parent breeds is described in U.S. Pat. No. 7,729,863, the entire contents of which are hereby incorporated by reference.

Once data have been entered, the user clicks a “submit” button (not shown) which causes UI component 242 to capture the entered data (step 504). Management component 240 communicates with UI component 242 and validates the data, for example by ensuring that the data entered for age and weight are numerical values greater than zero, that two or more parent breeds have been selected, and so on. If no weight is entered, or the animal is less than 1 year old, management component 240 interacts with SQL service 132 to query database 166 to retrieve average adult weights 428 for each parent breed. These average adult weights are in turn averaged in order to obtain an average weight for the purposes of the risk analysis.

Report generator component 246 may generate a header including general information, such as information relating to typical characteristics of the parent breeds (such as a general breed description 432 and temperament 436). If a PDF report has been selected (see above), report generator component 246 may open a PDF file 260 and write the header information (or a suitably transformed version of it) to PDF file 260. Report generator component 246 may also write additional text and image data to the PDF file 260, such as a cover page, table of contents and the like.

Management component 240 interacts with risk analysis component 244 to calculate health risk scores for the subject animal, on the basis of the validated input data. Risk analysis component 244 retrieves a list of all known heritable diseases stored in database 166, for each parent breed, to generate an initial list of candidate diseases. Then, a series of filtering processes is applied to the list of candidate diseases, to remove any diseases which are not relevant to the subject animal (step 506).

The filtering processes include:
A weight-based filtering process: any diseases which only affect individuals above a certain adult weight are removed from the list of candidates, if the subject animal's weight is below the threshold. Likewise, if a disease only affects animals below a certain adult weight, and the subject animal's weight is higher than that, then that disease is removed from the list. For the latter case, if the subject animal is less than 1 year old, the average adult weight of the parent breeds is used for filtering purposes.
An age-based filtering process: certain diseases only affect individuals in a certain age range or ranges. If the subject animal's age falls outside the range(s), those diseases are removed from the list of candidates.
A gender-based filtering process: some diseases (e.g. prostate cancer or cervical cancer) only affect individuals of one sex, and so can be filtered out if the subject animal is of the opposite sex.
Mode of inheritance filters:
   A dominant filter: if the disease is inherited in dominant fashion, and at least one parent breed can have the disease, then there is a possibility of the subject animal inheriting the disease and the disease is retained in the list of candidates.
   A recessive filter: if the disease is inherited in recessive fashion, and at least two of the parent breeds can have the disease, then there is a possibility of the subject animal inheriting the disease and it is retained in the list of candidates. Otherwise, it is filtered out.
   A sex-linked filter: some diseases will only be inherited by a male animal originating from an affected female. Thus, for such diseases, if the subject animal is female the disease is filtered out.

Any or all of the above filtering processes may be implemented by risk analysis component 244, and in any order. For example, the mode of inheritance filters may be applied before the age and weight filtering processes are applied.

Once the filtering processes have been applied, risk analysis component 244 retrieves, for each disease remaining in the candidate list, a disease score for each parent breed from database 166. The disease score represents the incidence and severity of the disease for a particular breed of dog, and is assigned in a manner which is described below. Risk analysis component 244 summarises the retrieved disease scores to obtain a single health risk score for each disease for the subject animal (step 508). For example, the scores may be summarised by addition or by averaging. It is convenient to average the scores since they will then be on the same scale for each animal, regardless of the number of parent breeds. The summary score may alternatively be a weighted sum or weighted average, with the weights being determined, for example, by the relative contributions of the parent breeds to the genotype of the subject animal, if that information is available.

Risk analysis component 244 applies a sorting process to the set of health risk scores to produce a ranked list of diseases (step 510). Report generator component 246 appends the ranked list to report data 250. In preferred embodiments, only a selected subset of the ranked list is appended, for example the top 3, top 5 or top 10 diseases in the ranked list. Each disease in the subset may have associated with it additional information including a description of the disease, screening information, and prevention information. Report generator component 246 may therefore append to the report (for display to the user in web browser 117, and/or for display in PDF file 260), for each disease in the subset, the associated additional information.

Report generator component 246 may also append a list of other diseases, for example the next 3, 5 or 10 entries in the ranked list below the selected subset, to the report.

Report generator component 246 may also generate, on the basis of the selected subset of highest ranking diseases, a vet schedule which includes, at scheduled ages, a list of tests which should be undertaken (step 512). The vet schedule may be generated by determining a set of screening ages 421 for the selected subset of diseases, and ordering the screening ages from earliest to latest. The screening ages 421 may be associated with disease screening method data 420. The vet schedule may be in the form of a table generated by the report generator component 246, and appended to PDF file 260 (step 514).

Generation of Disease Scores

A disease score is generated for each heritable condition by surveying the academic and clinical literature relating to the condition. The disease score for a particular breed is a composite score which represents a combination of the incidence and severity of the disease in the particular breed.

For each disease, and for each breed, the following set of severity parameters is considered:
A. The age at which it is fatal (if it is fatal)
B. Whether there is a cure
C. Whether it shortens the life of the animal
D. Whether it is painful or irritating to the animal
E. Whether it affects quality of life
F. Whether there is treatment available
G. Whether it is expensive for the owner
H. Whether screening for the disease is possible
I. Whether it is distressing for the owner

A predetermined set of scores is assigned for each parameter for one of several cases, typically Yes, No and Possible, in order to generate a template of possible values to select from when scoring any given disease. An exception is parameter A above which may have, for example, five possible values: 0 if the disease is non-fatal, 5 if fatal for babies, 98 if fatal for young adults, 69 for adults, and 36 for old age. The relative values reflect the relative impact of the disease being fatal at the respective ages.

The scores reflect the relative impact of that factor in assessing the disease. Thus, for example, if a disease does not affect quality of life, it will receive a score of 0, i.e. it has no impact on assessment of the disease. On the other hand, if the disease definitely affects quality of life, it will receive a score of 97.

The scores are conveniently on a scale between 0 and 100 though it will be realised that the scale can be varied in arbitrary fashion provided it is kept consistent within the disease database.

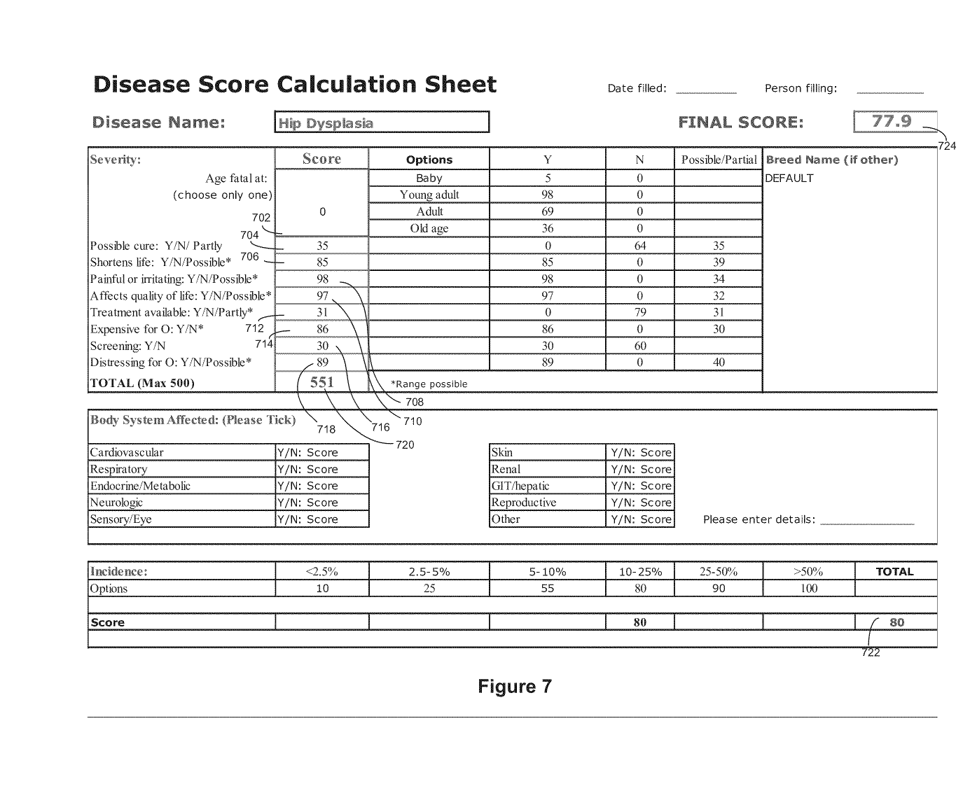

An exemplary set of template scores is set out in Table 1 below, and in the example shown in FIG. 7.

TABLE 1
Fixed severity parameter scores

| Parameter | Yes | No | Possible |
|---|---|---|---|
| If fatal, age of | Baby: 5 | | |
| fatality | Young adult: 98 | | |
| | Adult: 69 | | |
| | Old age: 36 | | |
| Cure possible? | 0 | 64 | 35 |
| Shortens life? | 85 | 0 | 39 |
| Painful/irritating? | 98 | 0 | 34 |
| Affects quality of life? | 97 | 0 | 32 |
| Treatment available? | 0 | 79 | 31 |
| Expensive for owner? | 86 | 0 | 30 |
| Screening possible? | 30 | 60 | |
| Distressing for owner? | 89 | 0 | 40 |

The severity parameters are therefore a mix of objective (e.g., is it fatal, and when) and subjective (e.g., is it distressing for the owner) parameters. The subjective parameters are generally assessed by a suitably qualified expert, for example a veterinary surgeon.

A severity score S can be assigned as follows. The person (e.g. veterinary surgeon) making the assessment surveys the literature, considering each factor in turn, and assigns a score, from the template scores, for each factor for the particular disease based on the results of the literature survey. It is also, of course, possible for the person to assign a score which is not in the template scores. For example, the impact of a treatment not being available for a particular disease may be considered to be greater than for other diseases, and so a score of greater than 50 may be allocated in that instance. In another example, the person making the assessment may assign a score which is between the minimum and maximum values in the template. The severity score S is then the sum of the scores for the respective severity factors.

For example, as depicted in FIG. 7, a scorecard 700 is generated for hip dysplasia in Boxers. Hip dysplasia is non-fatal (score of 0, cell 702); it can be incurable (score of 37, cell 704); it shortens the animal's life (score of 85, cell 706); it is painful or irritating (score of 98, cell 708); it affects quality of life (score of 97, cell 710); treatment can be available, but not always (score of 31, cell 712); it is expensive for the owner (score of 86, cell 714); it is not possible to screen for the disease (score of 30, cell 716); and it is distressing for the owner (score of 89, cell 718). The severity score S is then the sum of the scores 702, 704, 706, 708, 710, 712, 714, 716, 718, i.e. 551 (cell 720).

In addition to the above, an incidence score I is generated from the literature survey by firstly determining the rate of occurrence of the disease in each breed. Then, the rate of occurrence is converted to a score between 0 and 100. For example, the non-linear conversion shown in Table 2 can be used:

TABLE 2
Incidence scores

| Rate of occurrence | Incidence score |
|---|---|
| <2.5% | 10 |
| >=2.5%, <5% | 25 |
| >=5%, <10% | 55 |
| >=10%, <25% | 80 |
| >=25%, <=50% | 90 |
| >50% | 100 |

The severity scores and incidence score are then combined into a disease score using the following formula:

d=k(wₛS+wᵢfᵢI). (1)

In Equation (1), d is the disease score, k is an overall normalisation factor, wₛ is the weighting for the total severity score S, wᵢ is the weighting for the incidence score I, and fᵢ is a scaling factor introduced to put the total severity score S and the incidence score on a comparable scale. The weights wᵢ and wₛ add to 1 and the scaling factor fᵢ is calculated according to:

$${f}_{i} = \frac{{S}_{max}}{{I}_{max}} , \qquad ( 2 )$$

where Sₘₐₓ is the highest possible total severity score (i.e., the sum of the maxima of the individual severity parameter scores), and Iₘₐₓ is the highest possible incidence score (in this example, 100, though it may be an alternative value, e.g. 95).

Normalisation factor k is calculated according to:

$$k = \frac{{d}_{max}}{{S}_{max}} , \qquad ( 3 )$$

where dₘₐₓ is the upper limit of the disease score scale. So, for example, if it is desired to have all disease scores less than or equal to 100, dₘₐₓ is 100.

Once the disease score has been calculated, it is entered (as disease score 416) in database 166, for example via database administration component 248.

As will be apparent to those skilled in the art, many modifications of the above embodiments are possible whilst still falling within the scope of the invention. For example, although the particular examples relate to implementation in a client-server architecture, it will be appreciated that the invention can be implemented on a stand-alone computing device having features similar to those of server 110, and with, for example, software components 230 forming part of a dedicated software application which executes entirely on the stand-alone computing device.

1. A computer-implemented method of assessing health risk for a mixed breed animal, the method including:
providing disease data, the disease data including disease scores for a plurality of candidate diseases for each of a plurality of breeds;
receiving biological data relating to the mixed breed animal, the biological data including identification of two or more parent breeds which are in the ancestry of the mixed breed animal;
determining disease scores, from the disease data, for the two or more parent breeds;
summarising the disease scores across the two or more parent breeds to generate a combined health risk score for each of the candidate diseases; and
generating, from the combined health risk scores, a ranked list of diseases.

2. A method according to claim 1, wherein respective disease scores represent a combined severity and incidence for respective candidate diseases in respective breeds.

3. A method according to claim 2, wherein the severity is assessed according to a combination of severity parameters.

4. A method according to claim 3, wherein the severity parameters include one or more of: age at fatality of the disease, whether the disease can be cured, whether the disease shortens lifespan, whether the disease is painful or irritating, whether the disease affects quality of life, whether treatment is available for the disease, whether the disease is expensive for an owner of the mixed breed animal, whether it is possible to screen for the disease, or whether the disease is distressing for the owner.

5. A method according to claim 1, including, on the basis of the biological data, applying a filter to remove diseases which are not relevant to the mixed breed animal from the plurality of candidate diseases.

6. A method according to claim 5, wherein the biological data include one or more of age, sex and weight of the mixed breed animal.

7. A method according to claim 5, wherein the disease data includes mode of inheritance data associated with each of the candidate diseases, and wherein the filter is applied by comparing the biological data with the mode of inheritance data.

8. A method according to claim 1, including generating, on the basis of the ranked list, a recommended vet schedule for the mixed breed animal.

9. A system for assessing health risk of a mixed breed animal, including at least one processor which is configured to perform the method of claim 1.

10. A system for assessing health risk of a mixed breed animal, including:
a data store including disease data, the disease data including disease scores for a plurality of candidate diseases for each of a plurality of breeds;
a management component which is configured to receive biological data relating to the mixed breed animal, the biological data including identification of two or more parent breeds which are in the ancestry of the mixed breed animal; and
a risk analysis component which is configured to:
determine disease scores, from the disease data, for the two or more parent breeds;
summarise the disease scores across the two or more parent breeds to generate a combined health risk score for each of the candidate diseases; and
generate, from the combined health risk scores, a ranked list of diseases.
